(19) United States
(12) Patent Application Publication
(10) Pub. No.: US 2010/0319049 A1
(43) Pub. Date: Dec. 16, 2010

(54) TRUSTED AGENT FOR ADVERTISEMENT PROTECTION

(75) Inventors: Kedarnath A. Dubhashi, Redmond, WA (US); Rajeev Prasad, Bothell, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/482,278

(22) Filed: Jun. 10, 2009

(51) Int. Cl. H04L 9/32

(52) U.S. Cl. 726/1

(57) ABSTRACT

Embodiments are disclosed for providing trusted local enforcement of advertisement policies that are associated with digital content. One method includes receiving digital content and an associated advertisement policy at a network client. These items are received at the network client via a network from a content provider. A request is received to present the digital content with a media application of the network client. The method includes using a trusted agent of the network client to verify the authenticity of the advertisement policy in response to the request to present the content. The trusted agent operates to enforce the advertisement policy as a condition of presentation of the digital content at the media application.

### BACKGROUND

In some computing systems, network clients may access media content including music, videos, games, and webpages from a content provider via a communication network. Some content providers may present advertising content to users of these network clients along with requested media content. In many cases, the requested media content itself is provided free of charge, and revenue is generated as a result of activity in relation to the advertising content. In such an environment, it can be challenging to ensure that advertising content is presented in an intended manner, and to obtain reliable information and reporting of user interaction with advertising content.

### SUMMARY

Embodiments are disclosed which relate to providing trusted local enforcement of advertisement policies that are associated with digital content. In particular, a method is disclosed which includes receiving digital content and an associated advertisement policy at a network client. These items are received at the network client via a network from a content provider. A request is received to present the digital content with a media application of the network client. The method includes using a trusted agent of the network client to verify the authenticity of the advertisement policy in response to the request to present the content. The trusted agent operates to enforce the advertisement policy as a condition of presentation of the digital content at the media application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic depiction of an example embodiment of a computing system operative to enforce advertisement policies associated with digital content and protect the recording and reporting of actions attributed to presentation of advertising content.

FIG. 2 is a flow chart depicting an example embodiment of a method of enforcing advertisement policies at a network client.

FIG. 3 is a flow chart depicting an example embodiment of a method of protecting recording of actions attributed to presentation of advertising content at a network client.

### DETAILED DESCRIPTION

As briefly described in the Summary, embodiments are disclosed which relate to enforcing advertisement policies and the protection of recording of actions attributed to the presentation of the advertising content at a network client. The enforcement and protection functionality may be provided through use of a trusted agent at the network client. The trusted agent may be deployed at a network client that is un-trusted by a content provider. The trusted agent may in turn facilitate protection of advertisements that are provided to the network client by the content provider for presentation in association with featured media content or other digital content. Recorded actions that are attributed to the presentation of the advertisements at the network client, such as advertisement impressions, advertisement clicks, and advertisement conversions, may also be protected by the trusted agent. The trusted agent may aggregate these recorded actions over time and periodically forward an aggregation of the recorded actions to an advertisement administrator that communicates with the network client via a network.

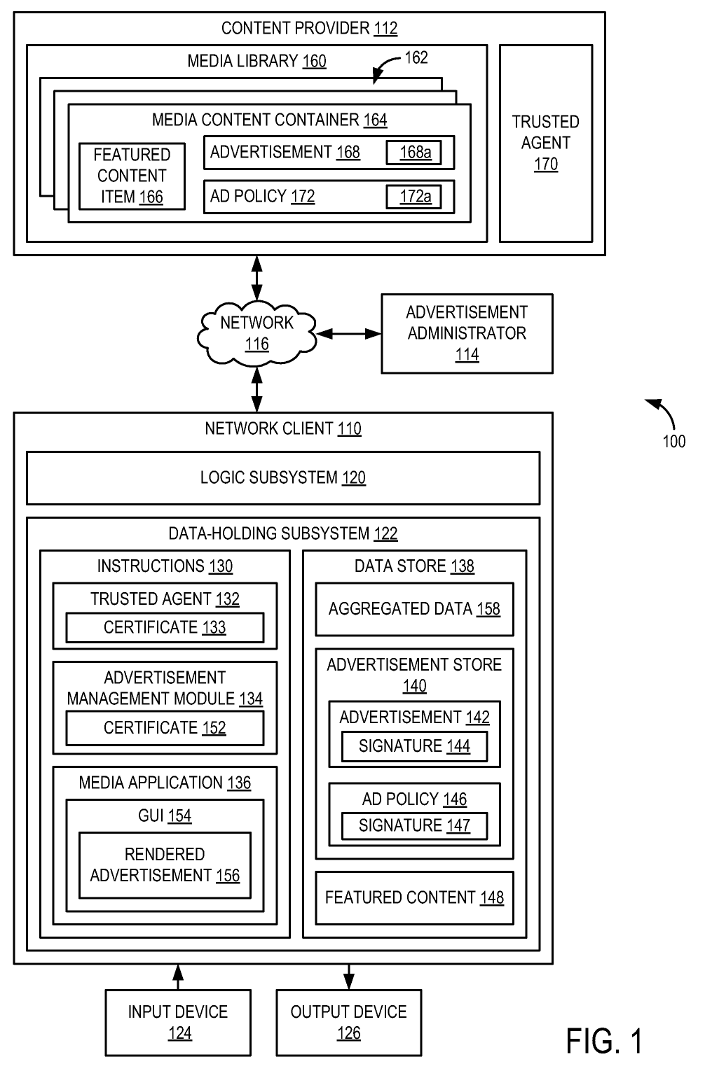

FIG. 1 presents an example environment in which the various disclosed embodiments may be provided. Specifically, FIG. 1 illustrates a schematic depiction of an example embodiment of a computing system 100. Computing system 100 includes one or more of a network client 110, a content provider 112, and an advertisement administrator 114, each of which may communicate with each other via a network 116. Network 116 may include at least one of a wide area network (WAN) (e.g., the Internet) and a local area network (LAN), or any other suitable communications link.

In at least some embodiments, content provider 112 and advertisement administrator 114 may each be embodied as programs operating at one or more network servers. For example, content provider 112 and advertisement administrator 114 may reside at the same network server or may reside at separate network servers. Furthermore, in at least some embodiments, advertisement administrator 114 may form a component of content provider 112.

Network client 110 may be embodied as a computing device that is operable by a client user. As a non-limiting example, network client 110 can be a mobile computing device, such as a mobile phone, a mobile media player, or a mobile computer. However, it will be appreciated that network client 110 may be any suitable computing device, including a desktop computer, a game console, or a network enabled television system.

Network client 110 may include a logic subsystem 120 that is configured to execute instructions for performing the various methods and processes described herein. As one example, logic subsystem 120 may include one or more processors. Network client 110 may further include a data holding subsystem 122 that includes or is configured to hold instructions 130 that are executable by logic subsystem 120. Instructions 130 of data-holding subsystem 122 may include one or more of a trusted agent 132, an advertisement management module 134, and a media application 136. In at least some embodiments, trusted agent 132, advertisement management module 134, and media application 136 are programs that are executable by logic subsystem 120.

As a non-limiting example, media application 136 may include at least one of a web browser application, a video player application, an audio player application, and an interactive game application. Media application 136 may be configured to present a featured content item 166 and advertisement 168 that are retrieved from content provider 112 via user operation of a graphical user interface 154. Graphical user interface 154 may be displayed to a client user via an output device 126. Featured content item 166 typically is provided as some form of encrypted digital content, as explained in more detail below. Typically, the encrypted digital content is associated with an advertisement policy 172, which may specify one or more advertisements (e.g., advertisement 168) that are to be presented as a condition of allowing the encrypted digital content to be decrypted and presented at network client 110 (e.g., by media application 136). The advertisement policy and/or specified advertisement may include digital signatures (e.g., digital signature 172a and digital signature 168a) that can be used at the network client to verify authenticity of the advertisement policy and advertisement.

Data-holding subsystem 122 may further include a data store 138. As will be described in further detail herein, data store 138 may be used by trusted agent 132 to store advertisements, featured content, and aggregated data that is attributed to client user interaction with the advertisements that are presented via media application 136.

Network client 110 may receive user input via an input device 124. As a non-limiting example, user input device 124 may include one or more of a keyboard, a mouse, a touch screen, a controller, a microphone, etc. Network client 110 may output (e.g., display) graphical content via an output device 126. As a non-limiting example, output device 126 may include a graphical display device such as a monitor or a television for displaying graphical user interface 154 of media application 136.

In at least some embodiments, content provider 112 may be configured to deploy a trusted agent 170 to network client 110 via network 116. Trusted agent 170 is shown and described herein as trusted agent 132 after being received by network client 110. Hence, it should be appreciated that trusted agent 170 and trusted agent 132 represent the same trusted agent at different instances in time. Similarly, advertisement 168 (and its digital signature 168a) are shown as received and stored at network client 110 as advertisement 142 and digital signature 144, and advertisement policy 172 (and its digital signature 172a) are shown as received and stored at network client 110 as advertisement policy 146 and digital signature 147. Trusted agent may also include a digital certificate 133 for purposes of digitally signing and/or encrypting data. As explained in various examples below, one use of the digital certificate is to digitally sign reporting data concerning interactions with advertising content, to allow verification of the reporting data.

Trusted agent 132 may be configured to receive advertisement 168 from content provider 112 via network 116. In at least some embodiments, trusted agent 132 may be configured to receive advertisement 168 from content provider 112 as a component of a media content container 164, where media content container 164 includes a featured content item 166 with which advertisement 168 is associated. As indicated above, the association between the content and the advertisement may result from the advertisement being specified in an advertisement policy associated with the content. Alternatively, advertising content may be fetched or otherwise retrieved independent of an advertisement policy.

Furthermore, in at least some embodiments, content provider 112 may include a media library 160 that hosts a plurality of different media content containers 162 that may be retrieved by the client user via network client 110. Each media container may include different featured content items and one or more advertisements that may be presented to the client user via media application 136. Featured content item 166 is depicted as featured content 148 after it is received at network client 110. Featured content 148 may additionally include one or more other featured content items that have been received from media library 160 of content provider 112.

The featured content items and advertisements described herein may take a variety of forms, including static image content, audio, text, and video content. As one example, featured content 148 (including featured content item 166) may include a webpage and advertisement 142 may include a static image or video advertisement that is embedded into the webpage. In this particular example, media application 136 may include a web browser for executing and rendering the webpage and embedded advertisement.

As another example, featured content 148 may include a video game or application program and advertisement 142 may include a static image or video advertisement that is presented within or as part of the video game or application program. In this particular example, media application 136 may include a dedicated or general purpose game or application hosting platform.

As yet another example, featured content 148 may include a movie, television show, or other suitable video format, and advertisement 142 may include a static image or video advertisement that is to be presented before, during, and/or after the presentation of the featured content. For example, a video advertisement may be presented periodically during presentation of the featured content or may be presented as a pre-roll before presentation of the featured content.

In addition to the audio/video and other examples above, the featured content and/or the advertising content may include text content. For example, featured content 148 may include text content, such as an article, essay, digital book, etc. Similarly, advertisement 142 may include text-based advertisements in addition to or instead of other types of advertising content.

The presentation of advertisement 142 to a client user via media application 136 is an action that may be referred to herein as an advertisement impression. Upon presentation of advertisement 142 to a client user as shown at rendered advertisement 156, the client user may operate input device 124 to interact with the advertisement. For example, the client user may operate input device 124 to select (e.g., “click”) the advertisement in order to access content that is associated with the advertisement, an action which may be referred to herein as an advertisement click. Upon selecting the advertisement and accessing content associated with the advertisement, the client user may again operate input device 124 to submit information, purchase products or services, or interact with the content that is associated with the advertisement, an action which may be referred to herein as an advertisement conversion. In at least some embodiments, advertisement management module 134 may be configured to identify one or more of these actions that are attributed to presentation of advertisements at or by media application 136.

Trusted agent 132 may be configured to verify the integrity and authenticity of the advertisements at the network client and/or the actions attributed to the presentation of the advertising content at the network client. In particular, trusted agent may be used to verify: (a) the authenticity of an advertising policy that is associated with encrypted digital content—e.g., verification of digital signature 147; (b) the authenticity of an advertisement that is to be presented during decryption and presentation of content—e.g., verification of digital signature 144; and/or (c) the authenticity of logged reporting data that describes clicks, conversions or other actions attributed to the presentation of advertising content at the network client.

A data store 138 may also be provided at network client 110. As indicated, the data store may be employed to store encrypted digital content (e.g., featured content 148), advertisement policies and advertisements associated with content (e.g., in advertisement store 140), and/or logged reporting data (e.g., aggregated data 158) which may include recorded information about actions that are made in connection with presented advertising content.

Trusted agent 132 may be configured to enforce advertisement policies associated with digital content, such as featured content 148. Such enforcement may occur with respect to a request by media application 136 to present featured content 148. Generally, the trusted agent enforces the advertisement policy as a condition of decrypting and presenting the content at the media application. In other words, if the advertisement policy is unavailable or invalid, or if it is not properly adhered to, the trusted agent prevents rendering of the desired digital content. One aspect of the enforcement may include verifying the advertisement policy associated with the digital content. For example, trusted agent can be employed to verify the authenticity of advertisement policy 146, via verification of digital signature 147. In this manner, the trusted agent can ensure that the advertisement policy has not been tampered with or otherwise altered. As previously indicated, the trusted agent may be configured to prevent decryption and presentation of the digital content if the advertisement policy is not verified/authenticated.

Advertisement policy 146 may specify one or more advertisements to be presented in connection with the digital content that the policy is associated with. For example, advertisement policy may specify that advertisement 142 is to be presented during decryption and presentation of featured content 148 by media application 136. In addition, the advertisement policy may define presentation parameters by which advertisement 142 is to be presented by the media application. The presentation parameters of policy 146 may include one or more of a right to play (e.g., view) the advertisement or the featured content item associated with the advertisement, the right to copy the featured content item associated with the advertisement, video output restrictions (e.g., only valid for HDCP over HDMI) for the display of the advertisement or the featured content item associated with the advertisement (e.g., as applied to output device 126), time restrictions (e.g., valid for the next 24 hours) for presentation of the advertisement or the featured content item associated with the advertisement, and other suitable rules. As a still further example, the advertisement policy may specify that advertisements have to be played at different stages during decryption and presentation of content. For example, an encrypted video might include a number of segments, and a specified advertisement would have to be presented before each segment is decrypted for presentation to the user. Accordingly, the trusted agent 132 may be configured to decrypt and present a particular portion of featured content 148 only upon successful presentation of a verified advertisement specified in the advertisement policy associated with the featured content.

In addition to verifying advertisement policies, trusted agent 132 may be further configured to verify the authenticity of particular advertisements specified in an advertisement policy. For example, the trusted agent could verify the authenticity of advertisement 142 via checking of digital signature 144. Accordingly, if an advertisement policy specified that advertisement 142 be presented along with a particular piece of digital content, the trusted agent can be used to verify that the advertisement was authentic and had not been tampered with or altered. If the signature checking fails and the advertisement is not verified, then the trusted agent may be configured to prevent rendering (decryption and presentation) of the digital content.

As part of its enforcement functionality, trusted agent may receive advertisements, or requests to present advertisements, in various ways. For example, trusted agent 132 may receive an advertisement request to present advertisement 142 via media application 136. In at least some embodiments, trusted agent 132 may receive the advertisement request from advertisement management module 134 on behalf of media application 136. In other embodiments, the advertisement management module may form a component of media application 136, whereby the advertisement request is received from the advertisement management module of the media application. In still other embodiments, the advertisement management module may form a component of the trusted agent, whereby the advertisement request is received from the media application at the trusted agent via the advertisement management module. In addition, requested advertisements may be stored locally (e.g., in advertisement store 140) for later presentation, or retrieved via network 116 at the time they are to be presented, from content provider 112 or other sources. While it will be desirable in some settings to store advertisements locally for later presentation, in other instances it will be desirable to employ “just-in-time” retrieval of advertising content from advertising sources over the network.

After presentation of one or more advertisements via media application 136, trusted agent 132 may be configured to receive an action logging request indicating one or more actions attributed to presentation of the advertisement (e.g., advertisement 142) by media application 136. As a non-limiting example, the one or more actions indicated by the action logging request may include at least one of an advertisement impression, an advertisement click, and an advertisement conversion. In at least some embodiments, the action logging request may be received by trusted agent 132 from advertisement management module 134. Typically, the action logging request is digitally signed to ensure authenticity and protect against tampering. For example, in at least some embodiments, the action logging request may further indicate a digital certificate 152 of advertisement management module 134. Trusted agent 132 may be configured to verify digital certificate 152 of advertisement management module 134 and record the one or more actions indicated by the action logging request in data store 138 as aggregated data 158 if digital certificate 152 of advertisement management module 134 is verified by trusted agent 132.

Hence, in at least some embodiments, trusted agent 132 may record the one or more actions only after verifying that the one or more actions are received from the advertisement management module and are received in accordance with the policy of the advertisement, thereby reducing what may be referred to as “click fraud”. Furthermore, the trusted agent typically will verify the integrity of data given by advertisement management module 134 by checking that the signature on the reported data is valid and is from or associated with the digital certificate of the advertisement management module. For example, trusted agent 132 may be configured to disregard the one or more actions indicated by the action logging request if digital certificate 152 of advertisement management module 134 is not verified by trusted agent 132. In at least some embodiments, trusted agent 132 may be further configured to encrypt the aggregated data including the one or more actions before recording the one or more actions in data store 138.

Trusted agent 132 may be further configured to receive a reporting request from advertisement management module 134. In response to the reporting request, trusted agent 132 may retrieve aggregated data 158 from data store 138 in order to report the aggregated data to advertisement administrator 114. To protect against tampering, the reporting data may be digitally signed (e.g., using digital certificate 133 of trusted agent 132) prior to transmission to advertisement administrator 114.

It should be appreciated that alternate embodiments may be employed in which digital content is unencrypted. In particular, even where a content provider provides unprotected (unencrypted) content, the present systems and methods may still be employed to ensure that advertisements are presented as intended and that the integrity of reporting data is preserved. In particular, advertisement policies and/or advertisements may still be verified (e.g., via digital signature checking), and a trusted agent may operate to prevent presentation of requested content in the event of failed verification(s). Also, even where content is not encrypted, it will often be desirable to provide the described reporting functionality relating to user interactions with advertisements, and to ensure that reported data is authentic and protected against tampering.

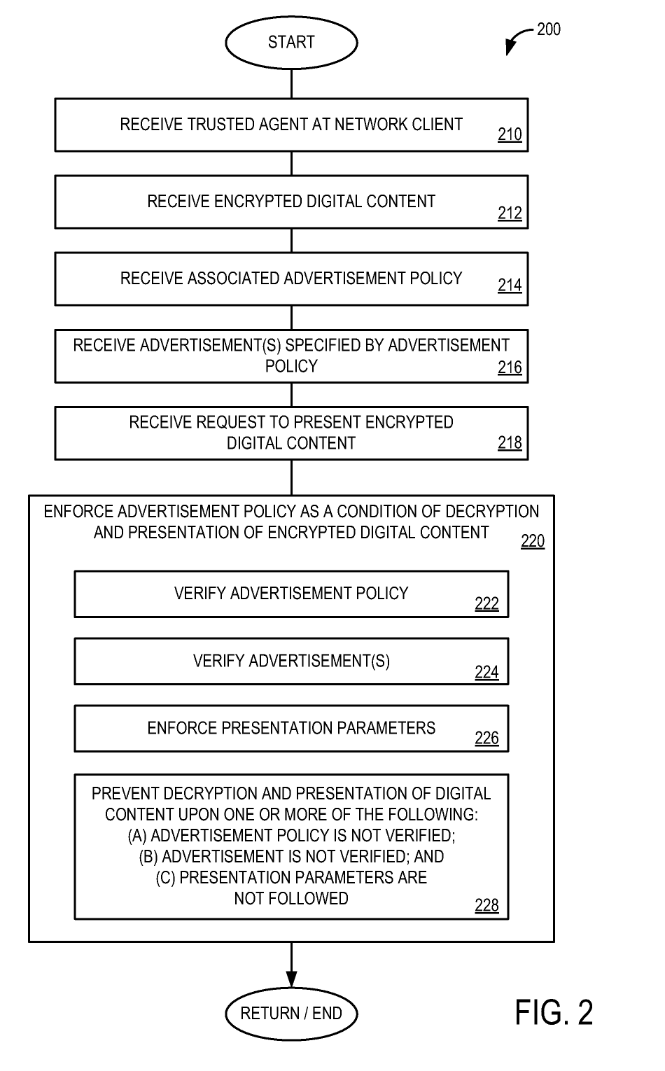

FIG. 2 illustrates a flow chart depicting an example embodiment of a method 200 of enforcing advertisement policies at a network client. In at least some embodiments, one or more of the processes of method 200 may be performed by trusted agent 132 of FIG. 1, which may be deployed at the network client. Beginning at 210, method 200 includes receiving a trusted agent at a network client. The trusted agent may be provided by a content provider, such as content provider 112, or alternately by a third party and made available for use by various content providers that distribute protected digital content and associated advertising.

At step 212, method 200 includes receiving encrypted digital content at the network client. As previously discussed, the encrypted digital content may take a variety of forms, and typically is associated with an advertisement policy specifying one or more advertisements that are to be presented in connection with the encrypted digital content. Furthermore, the advertisement policy may specify presentation parameters governing how the advertisement(s) is/are to be presented. Accordingly, at step 214 method 200 may include receiving an advertisement policy associated with the encrypted digital content, and at step 216, one or more advertisements may be received at the network client. Advertisements may be received at various different times. In one example, advertisements may be retrieved soon after the advertisement policy is received at the client. In another example, advertisements are retrieved just prior to the point where their authenticity is verified and they are presented to the user.

Typically, as in some of the above examples, the advertisement policy and advertisement(s) will be digitally signed (e.g., at content provider 112) in order to provide a verification mechanism to ensure authenticity of the policy and advertisements. A trusted agent, such as trusted agent 132, may perform the verifications locally at the network client. Furthermore, the received advertisement may be stored locally for later presentation (e.g., in advertisement store 140 of FIG. 1), or may be downloaded via a network link and immediately presented as part of the content request.

At step 218, method 200 may further include receiving a request to render the encrypted digital content, for example, in order to present it via media application 136 (FIG. 1). However, as shown at step 220, the method is implemented to enforce the advertisement policy in connection with rendering the requested content. Specifically, a trusted agent may enforce the advertisement policy that is associated with the requested content, as a condition of decrypting the content and presenting it via a media application.

More particularly, as shown at steps 222 and 224, the enforcement may include verifying the advertisement policy and/or advertisement or advertisements that are specified by the policy. In the context of FIG. 1, an example of such verification is trusted agent 132 verifying advertisement policy 146 via digital signature 147 and advertisement 142 via digital signature 144.

Continuing with FIG. 2, enforcement of the advertisement policy may further include, at step 226, enforcing the presentation parameters for advertising content, as may be specified in the advertisement policy. As discussed above, presentation parameters may include rights to play and/or copy, restrictions on video output and times at which requested content can be rendered, specifications that advertisements be played in a particular sequence, or at particular times relative to segments of the requested content, etc.

As shown at step 228, under a variety of conditions, the method may include preventing requested content from being rendered (e.g., by media application 136 of FIG. 1). Specifically, the method may include preventing decryption and presentation of encrypted digital content that has been requested at step 218 upon one or more of the following: (a) failed verification of the advertisement policy; (b) failed verification of an advertisement specified by the advertisement policy; and (c) any violation of presentation parameters that are dictated in the advertisement policy. In this way, the method can ensure that desired advertisements are presented in the intended manner when a network user gains access to protected digital content.

The described enforcement of advertisement policies and associated advertisements may be used to enforce what may be referred to as “creative contracts.” In such a setting, various creatives (music, pictures, etc.) may be employed in advertising, and their usage in the advertising may be bound by various contracts. The approaches described herein may be used to enforce such contracts. For example, various terms of a creative contract may be implemented as the previously-described presentation parameters of advertisement policy 146. Thus, as part of rendering requested content, the trusted agent can enforce the underlying contract terms for the creative material as a condition of presenting the requested content.

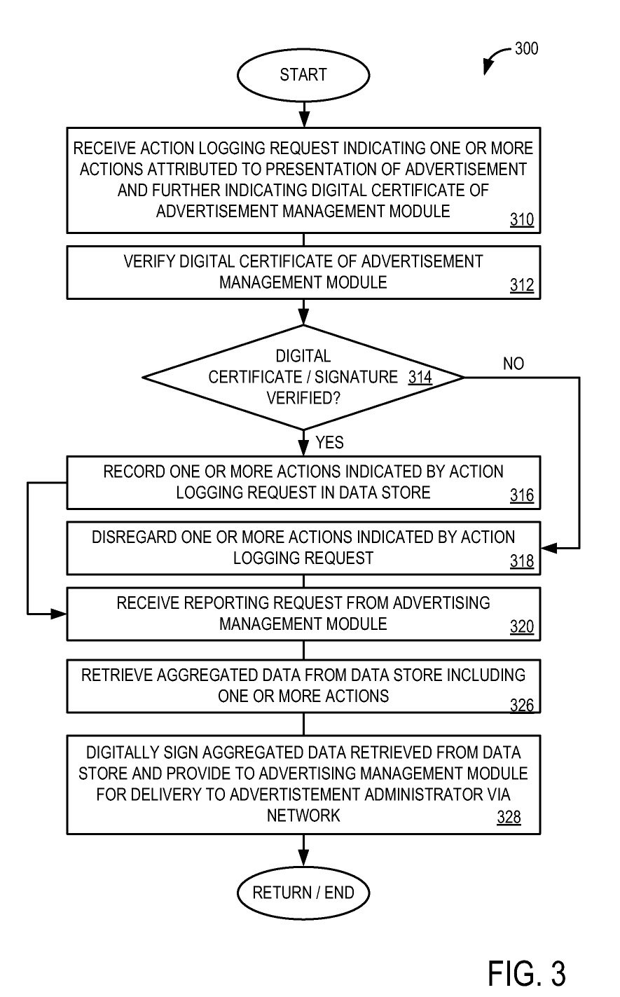

FIG. 3 illustrates a flow chart depicting an example embodiment of a method 300 of protecting the recording of actions attributed to presentation of advertising content at a network client. In at least some embodiments, one or more of the processes of method 300 may be performed by trusted agent 132 of FIG. 1, which may be deployed at the network client by a content provider.

At 310, method 300 includes receiving an action logging request from the advertisement management module indicating one or more actions attributed to presentation of the advertisement by the media application and further indicating a digital certificate of the advertisement management module. In some embodiments, the one or more actions indicated by the action logging request include at least one of an advertisement impression, an advertisement click, and an advertisement conversion.

At 312, method 300 includes verifying the digital certificate of the advertisement management module. In particular, the action logging request of step 310 may be digitally signed (e.g., by the advertisement management module). At 314, method 300 may include judging whether the digital certificate (which may include a digital signature) has been verified at 312. If verification is successful, then at 316, method 300 includes recording the one or more actions indicated by the action logging request in a data store.

If verification is not successful, then at 318, method 300 includes disregarding the one or more actions indicated by the action logging request. Alternatively, method 300 may include recording the one or more actions along with an indicator that may be interpreted by the advertisement administrator as indicating that the action logging request was not verified for the one or more actions that were recorded.

At 320, method 300 includes receiving a reporting request from the advertisement management module. In response to the reporting request, at 326, method 300 includes retrieving aggregated data from the data store. As in the above examples, the aggregated data may include at least the one or more actions that have been recorded in the data store as a result of the action logging request. Typically, the aggregated data will include actions recorded as a result of multiple action logging requests made with respect to multiple different advertisements. At 328, method 300 includes providing the aggregated data retrieved from the data store to the advertisement management module for delivery to an advertisement administrator via the network. In this way, aggregated data including the one or more actions attributed to presentation of the advertisement via the media application may be provided to the advertisement administrator. Typically, as part of this reporting process, the aggregated data will be digitally signed (e.g., by trusted agent 132) when it is reported out the advertisement administrator or other outside entity, to verify authenticity and protect against tampering.

As discussed above with reference to FIG. 1, it should be appreciated that the exemplary methods of FIGS. 2 and 3 may be employed in connection with requests to present unencrypted content. In particular, in FIG. 2, the content received at step 212 may optionally be unencrypted. In such a case, the enforcement actions of steps 220, 222, 224, 226 and 228 would proceed as described above, except without the described decryption operations. Similarly, the action-logging requests and reporting of FIG. 3 may be employed regardless of the encryption status of the content with which the advertising is associated.

It will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory of a data-holding subsystem, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for enforcing advertisement policies, comprising:
receiving, at a network client, digital content and an advertisement policy associated with the digital content, the digital content and advertisement policy being provided via a network from a content provider;
receiving a request to present the digital content via a media application of the network client;
in response to the request, verifying authenticity of the advertisement policy with a trusted agent on the network client; and
enforcing the advertisement policy, via operation of the trusted agent, as a condition presentation of the digital content at the media application.

2. The method of claim 1, where enforcing the advertisement policy includes presenting one or more advertisements specified by the advertisement policy in accordance with presentation parameters specified by the advertisement policy.

3. The method of claim 2, where enforcing the advertisement policy includes verifying digital signatures of the one or more advertisements specified by the advertisement policy.

4. The method of claim 3, where enforcing the advertisement policy includes preventing presentation of the digital content at the media application if the digital signatures of the one or more advertisements specified by the advertisement policy are not verified.

5. The method of claim 2, further comprising:
receiving, from an advertisement management module of the network client, a digitally-signed action logging request indicating one or more actions attributed to presentation of the one or more advertisements specified by the advertisement policy;
verifying the digitally-signed action logging request; and
recording the one or more actions indicated by the digitally-signed action logging request in a data store if the digitally-signed action logging request is verified.

6. The method of claim 5, where the one or more actions indicated by the digitally-signed action logging request include at least one of an advertisement impression, an advertisement click, and an advertisement conversion.

7. The method of claim 5, further comprising:
receiving a reporting request from the advertisement management module;
retrieving aggregated data from the data store in response to the reporting request, the aggregated data including at least the one or more actions recorded in the data store; and
digitally signing and providing the aggregated data retrieved from the data store to the advertisement management module for delivery to an advertisement administrator via the network.

8. The method of claim 5, further comprising disregarding the one or more actions indicated by the digitally-signed action logging request if the digitally-signed action logging request is not verified.

9. The method of claim 1, where verifying authenticity of the advertisement policy includes verifying a digital signature of the advertisement policy.

10. The method of claim 9, where enforcing the advertisement policy includes preventing presentation of the digital content at the media application if the digital signature of the advertisement policy is not verified.

11. A computing device, comprising:
a logic subsystem; and
a data holding subsystem including instructions executable by the logic subsystem to:
receive digital content and an advertisement policy associated with the digital content, the digital content and advertisement policy being provided via a network from a content provider;
receive a request to present the digital content via a media application;
in response to the request, verify authenticity of the advertisement policy; and
enforce the advertisement policy as a condition of presentation of the digital content at the media application.

12. The computing device of claim 11, where the instructions are executable to enforce the advertisement policy by presenting one or more advertisements specified by the advertisement policy in accordance with presentation parameters specified by the advertisement policy.

13. The computing device of claim 12, where the instructions are executable to prevent presentation of the digital content at the media application if digital signatures of the one or more advertisements are not verified.

14. The computing device of claim 11, where the instructions are executable to prevent presentation of the digital content at the media application if a digital signature of the advertisement policy is not verified.

15. The computing device of claim 11, where the instructions are further executable to:
receive a digitally-signed action logging request indicating one or more actions attributed to presentation of one or more advertisements specified by the advertisement policy;
verify the digitally-signed action logging request; and
record the one or more actions indicated by the digitally-signed action logging request in a data store if the digitally-signed action logging request is verified.

16. The computing device of claim 15, where the instructions are further executable to:
receive a reporting request;
retrieve aggregated data from the data store in response to the reporting request, the aggregated data including at least the one or more actions recorded in the data store; and
deliver the aggregated data to an advertisement administrator via the network.

17. The computing device of claim 15, where the one or more actions indicated by the digitally-signed action logging request include at least one of an advertisement impression, an advertisement click, and an advertisement conversion.

18. A method for enforcing advertisement policies, comprising:
receiving, at a network client, digital content and an advertisement policy associated with the digital content, the digital content and advertisement policy being provided via a network from a content provider;
receiving a request to present the digital content via a media application of the network client;
in response to the request, verifying authenticity of the advertisement policy with a trusted agent on the network client;
enforcing the advertisement policy, via operation of the trusted agent, as a condition of presentation of the digital content at the media application, where such enforcing of the advertisement policy includes causing the media application to present an advertisement specified by the advertisement policy;
receiving a digitally-signed action logging request at the network client indicating one or more actions attributed to presentation of the advertisement by the media application;
verifying the digitally-signed action logging request at the network client; and
recording the one or more actions indicated by the digitally-signed action logging request in a data store of the network client if the digitally-signed action logging request is verified.

19. The method of claim 18, further comprising:
receiving a reporting request from an advertisement management module of the network client;
retrieving aggregated data from the data store in response to the reporting request, the aggregated data including at least the one or more actions recorded in the data store; and
digitally signing and providing the aggregated data retrieved from the data store to the advertisement management module for delivery to an advertisement administrator via the network.

20. The method of claim 18, where enforcing the advertisement policy includes preventing presentation of the digital content at the media application if a digital signature of the advertisement specified by the advertisement policy is not verified.
